(19) United States
(12) Patent Application Publication
(10) Pub. No.: US 2019/0120126 A1
(43) Pub. Date: Apr. 25, 2019

(54) Method for Using Combustion Engine and Combustion Engine Assembly

(71) Applicant: Timo Janhunen, Helsinki (FI)

(72) Inventor: Timo Janhunen, Helsinki (FI)

(21) Appl. No.: 16/091,504

(22) PCT Filed: Apr. 11, 2017
(86) PCT No.: PCT/FI2017/050258

§ 371 Date: Oct. 4, 2018

(30) Foreign Application Priority Data
Apr. 11, 2016 (FI) 20160094

(51) Int. Cl. F02B 37/04; F02B 39/04; F02B 29/08; F02B 33/06

(52) U.S. Cl. CPC F02B 37/04; F02B 39/04; F02M 2023/008; F02B 33/06; F02B 29/08

(57) ABSTRACT

Method and internal-combustion engine arrangement, which comprises an internal-combustion engine comprising at least one cylinder and piston, which is arranged to operate according to the split-cycle principle, a turbocharger connected to the exhaust side of the engine for compressing the air with the aid of the exhaust gases of the internal-combustion engine in the first stage, a first intercooler for cooling the compressed air, and a mechanical compressor for further compressing the aid in the second stage, a second intercooler for cooling the compressed air, and in which the output of the mechanical compressor can be regulated according to the air requirement of the engine. The air thus compressed and cooled is led to the cylinder (cylinders) of the engine with the aid of its (their) extremely fast intake-air valve system as the engine's piston moves towards its upper dead centre.

### FIELD OF TECHNOLOGY

The present invention relates to a method for reducing throttling losses in the gas exchange of an internal-combustion engine.

### BACKGROUND OF THE INVENTION

In piston engines the gas exchange in the cylinders is based on the vacuum and excess pressure created by the movement of the piston and the correctly timed opening and closing of the valves. Normally, the output of an internal-combustion engine is regulated by throttling the intake-air port, This leads to throttling losses and a reduction in efficiency, particularly on part-load of the engine. A usual method for reducing the throttling losses of an internal-combustion engine is to close the intake valve earlier or later than normal. Thus losses can be partly reduced and the part-load efficiency of the engine increased. Nevertheless, losses remain and the part-load efficiency of the engine is not the best possible. In direct-injection engines, both petrol and diesel, throttling of the intake port can be omitted on part load, but this leads to a lower average cylinder temperature and thus to higher CO, HC, and particle emission, due to the high air factor,

### SUMMARY OF THE INVENTION

The invention is defined according to the characteristics of the independent Claims. Some particular characteristics are described in the dependent Claims.

According to the first characteristic of the invention, an internal-combustion engine comprising at least one cylinder and piston is operated according to the split-cycle principle, in such a way that air is compressed in the first stage with the aid of the engine's exhaust gases using a turbocharger, the compressed air is cooled and is further compressed in the second stage using a mechanical compressor, the compressed air is cooled and the output of the mechanical compressor is regulated according to the engine's air requirement. Then the compressed and cooled air is led to the engine's cylinder with the aid of an extremely fast intake-air valve arrangement 5, (FIGS. 1 and 2) as the engine's piston moves towards its top dead centre.

According to the second characteristic of the invention, the air is compressed in the second stage using a mechanical adjustable piston compressor.

According to the third characteristic of the invention, the output of air of the adjustable piston compressor is regulated by controlling its intake-air valves according to the early intake valve close method.

According to the fourth characteristic of the invention, the output of air of the adjustable piston compressor is regulated by controlling its intake-air valves according to the late intake valve dose method.

According to the fifth characteristic of the invention, the output of air of the adjustable piston compressor is regulated by altering the timing of its intake and exhaust-air valves.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 shows the operating principle of a split-cycle internal-combustion engine.

FIG. 2 shows a device, with the aid of which at least some embodiments of the invention can be implemented.

### DETAILED DESCRIPTION OF PREFERRED EMBODIMENTS

Definitions

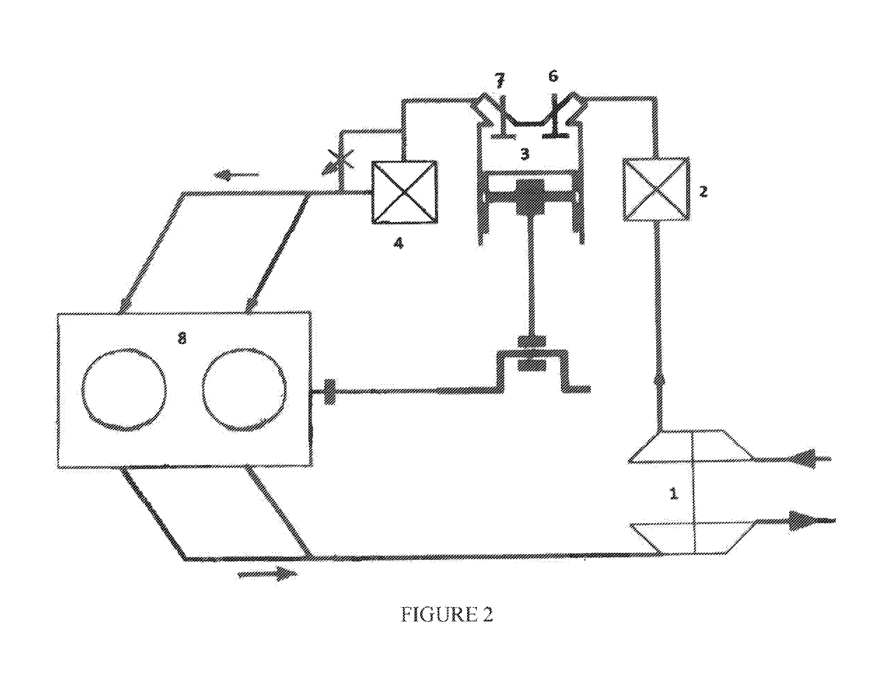

In this context, the term split-cycle engine refers to a piston engine, in which the exchange of gas in the cylinder takes place during one rotation of the crankshaft under the control of valves and part of the work of compressing the intake air is done by a compressor external to the engine, according to FIG. 2.

The term early intake valve close method refers to the closing of the intake valve before the end of the intake stroke.

The term late intake valve close method refers to keeping the intake valve open partly during the compression stroke, in such a way that part of the air in the cylinder flows back into the intake-airport.

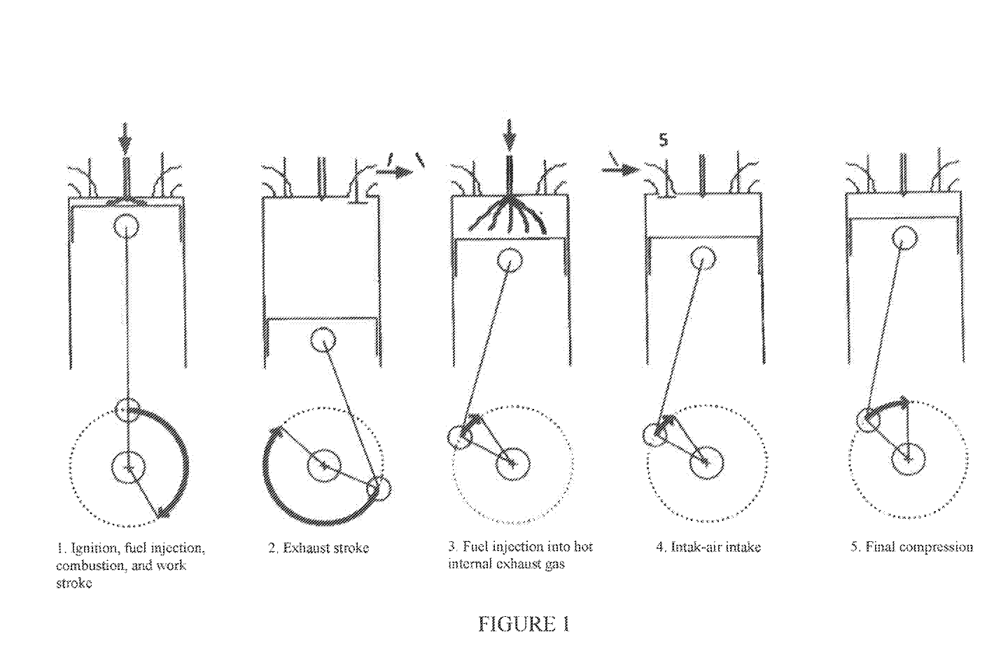

The present method is based on a new type of engine, which is shown in FIGS. 1 and 2. The engine is a so-called “split-cycle” type engine 8, in which part of the compression work of the engine 8 has been transferred to a separate compressor 3, according to FIGS. 1 and 2. The engine's intake-air gas exchange is based on the stages: compressing of the air using a turbocharger 1, cooling in an intercooler 2, further compression using a piston compressor 3, cooling in a second intercooler 4, and the engine's 8 extremely rapid intake-air valve arrangement 5. The functioning of this gas-exchange arrangement has been proven by engine tests and CFD simulation (see e.g.: www.aumet.fi).

The engine's work cycle is shown in FIG. 1. It begins with injection of the ignition fuel (at about the upper dead centre of the piston) into a hot, compressed fuel-air mixture (FIG. 1, item 1) and the subsequent combustion and work stroke. After this, the engine's exhaust valve opens and the exhaust stroke follows (FIG. 1, item 2), when the piston pushes the combustion gases out of the cylinder and into the exhaust port. After that, fuel is injected into the hot, internal combustion gas (FIG. 1, item 3). After this, the air that has been compressed by the piston compressor (3) and intercooled (intercooler 4, FIG. 2) is led with the aid of a rapid intake-air valve arrangement (5), (FIG. 1, item 4) into the engine's cylinder as its piston moves towards its upper dead centre. After this, the air-fuel mixture created is compressed at the upper dead centre of the piston (FIG. 1, item 5),

If it is desired to keep the engine's fuel and air mixture ratio, the lambda, in an optimal range to achieve a good efficiency, to reduce nitrogen oxides and particles and the engine's other detrimental emissions, and to permit the good further processing of exhaust gases, it must be possible to regulate the amount of air produced by the compressor 3. In the embodiment of FIG. 2, this is done by adjusting the opening and closing of the intake valves of the compressor 6, according to the so-called “early intake valve close”, or “late intake valve close” method. Ready components (see supercharging-turbocharger) are available of the market for implementing the method. In the same way, the opening and closing of the compressor's exhaust valve 7 should be controlled in order to achieve an optimal result. Ready components for this are available on the market. The optimal opening and closing point of both the intake and exhaust valves is optimized using software known in the field for the case-specific adjustment of the valves, and also various pressure and other sensors can be used, as is the practice in the field. The pressure level of the compressor, which is significantly lower than that of the engine, makes this adjustment easy to implement.

The compressor's valves 6 and 7 are forced-acting disc valves, similar to those in a car's engine, because self-acting compressor valves do not generally operate at a speed of more than 3000 rpm and their flow-efficiency is poorer than that of disc valves. The valves' camshafts are adjusted so that the valves open at the right time, as described above. The advantage of a mechanical valve mechanism is that, if the valves' camshaft followers are roller followers, they return most of the valves' opening work to the camshafts. This is not the case e.g. in hydraulic systems, such as, e.g. Fiat Multiair.

The engine intake-air gas-exchange system described here regulates the amount of air coming to the engine, without throttling losses, and thus permits a high engine efficiency and low emissions, even on part load. The solution described is completely new in the field and permits the an engine to always operate at an optimal operating point, irrespective of the load.

The engine's (8) operating principle is shown is FIG. 1, in which item 4, the intake of intake air, shows the rapid gas exchange taking place in the engine's cylinder with the aid of an extremely fast intake-air valve arrangement 5. As can be seen from the engine's gas exchange picture 2, the air (gas) coming to the engine 8 is first compressed in a turbocharger 1, after which the air is cooled in an intercooler 2 and is then led to a compressor 3, the output of which can be regulated and the compressed air then led to an intercooler 4 and then to the engine's cylinder (FIG. 1, intake-air intake, item 4) with the aid of the engine's extremely fast intake-air valve arrangement 5, while the engine's piston moves towards its upper dead centre.

The invention comprises, among others, the following embodiments:

Method for minimizing the throttling losses of the gas exchange of an internal-combustion engine, which comprises a so-called. “spit-cycle” gas-exchange system, according to FIGS. 1 and 2, on the intake-air side of the engine 8, which is based on the following stages: turbocharger 1, intercooler 2, mechanical compressor 3, intercooler 4, and the engine's extremely fast intake-air valve system 5. The air output of the mechanical compressor (3) can be regulated according to the engine's requirement, without throttling losses.

Method, in which its mechanical, adjustable compressor (3) is a piston compressor.

Method, in which the regulation of its piston compressor 3 is based on the so-called “early intake valve close” method and the control of its intake 6 and exhaust 7 valves for achieving the said adjustment.

Method, in which the regulation of its piston compressor 3 is based on the so-called “late intake valve close” method and the control of its intake 6 and exhaust 7 valves for achieving the said adjustment.

Method, in which the timing of the valves 6 and 7 of its piston compressor 3 is altered as required, to be able to minimize the throttling losses of the gas exchange of the internal-combustion engine.

### INDUSTRIAL APPLICABILITY

The invention can be applied in internal-combustion engines.

1. A method for operating an internal-combustion engine, comprising at least one cylinder and piston, according to the split-cycle principle, in such a way that the engine's intake air is compressed in the first stage with the aid of the internal-combustion engine's exhaust gases in a turbocharger, the compressed air is cooled and further compressed in a second stage using a mechanical compressor, the compressed air is cooled and the output of the mechanical compressor is regulated according to the engine's air requirement, and the compressed and cooled air is taken to the engine's cylinder with the aid of its extremely fast intake-air valve arrangement as the engine's piston moves towards its upper dead centre.

2. The method according to claim 1, in which the air is compressed in a second stage using a mechanical adjustable piston compressor.

3. The method according to claim 2, in which the output of air of the adjustable piston compressor is regulated by controlling its intake-air valves according to the early intake valve close method.

4. The method according to claim 2, in which the output of air of the adjustable piston compressor is regulated by controlling its intake-air valves according to the late intake valve close method.

5. The method according to claim 2, in which the output of air of the adjustable piston compressor is regulated by altering the timing of its intake and exhaust valves.

6. An internal-combustion engine arrangement, which comprises an internal-combustion engine comprising at least one cylinder and piston, which is arranged to operate according to the split-cycle principle, a turbocharger connected to the exhaust side of the engine for compressing the air in the first stage with the aid of the exhaust gases of the internal-combustion engine, a first intercooler for cooling the compressed air, and a mechanical compressor for further compressing the air in the second stage, a second intercooler for cooling the compressed air, and in which the output of the mechanical compressor can be regulated according to the air requirement of the engine.

7. The arrangement according to claim 6, in which the mechanical compressor is an adjustable piston compressor.
